(19) United States
(12) Patent Application Publication
(10) Pub. No.: US 2026/0032484 A1
(43) Pub. Date: Jan. 29, 2026

(54) PREDICTED MEASUREMENT REPORTING

(71) Applicant: InterDigital Patent Holdings, Inc., Wilmington, DE (US)

(72) Inventors: Filipe Conceicao, London (GB); Oumer Teyeb, Montreal (CA); Yugeswar Deenoo Narayanan Thangaraj, Chalfont, PA (US); James Miller, Northport, NY (US); Tezcan Cogalan, London (GB)

(73) Assignee: InterDigital Patent Holdings, Inc., Wilmington, DE (US)

(21) Appl. No.: 18/996,579

(22) PCT Filed: Jul. 18, 2023
(86) PCT No.: PCT/US2023/028022

§ 371 Date: Jan. 17, 2025

Related U.S. Application Data
(60) Provisional application No. 63/390,057, filed on Jul. 18, 2022.
(60) Provisional application No. 63/410,812, filed on Sep. 28, 2022.

(51) Int. Cl. H04W 24/10

(52) U.S. Cl. CPC H04W 24/10

(57) ABSTRACT

A WTRU may be configured to determine at least one predicted measurement. The at least one predicted measurement may comprise, for example, at least one predicted air interface measurement. The WTRU may determine, based on the at least one predicted measurement, a predicted event and a predicted time associated with the predicted event. The predicted event may comprise, for example, the at least one predicted measurement being less than a threshold. The WTRU may determine, based on the predicted event, the predicted time, and a time offset, to send a report indicating the predicted event. The WTRU may determine to send the report indicating the predicted event, for example, on a condition that a difference between a current time and the predicted time is greater than the time offset. If the condition is met, the WTU may send the report indicating the predicted event.

### CROSS-REFERENCE TO RELATED APPLICATIONS

This application claims the benefit of Provisional U.S. Patent Application No. 63/390,057, filed Jul. 18, 2022, and U.S. Provisional Patent Application No. 63/410,812, filed Sep. 28, 2022, the disclosures of which are incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for artificial intelligence (AI)-based anticipated or predicted measurement reporting in wireless systems.

A wireless transmit and receive unit (WTRU) may be configured to determine at least one predicted measurement. The at least one predicted measurement may comprise, for example, at least one predicted air interface measurement. The WTRU may determine, for example, a first predicted measurement at a first predicted time and a second predicted measurement at a second predicted time.

The WTRU may determine, based on the at least one predicted measurement, a predicted event and a predicted time associated with the predicted event. The predicted event may comprise, for example, the at least one predicted measurement being less than a threshold or greater than a threshold. The predicted time may comprise a time interval.

The WTRU may be configured to receive configuration information comprising a time offset. The time offset may indicate a difference between a current time and a predicted time. The WTRU may determine, based on the predicted event, the predicted time, and the time offset, to send a report indicating the predicted event. The WTRU may determine to send the report indicating the predicted event, for example, on a condition that a difference between a current time and the predicted time is greater than the time offset. If the condition is met, the WTRU may send the report indicating the predicted event.

The WTRU may be further configured to determine a predicted confidence associated with the predicted event. The report that is sent by the WTRU may comprise an indication of the predicted event, the at least one predicted measurement, and the predicted confidence.

A WTRU may be configured to trigger anticipated or predicted measurement reporting based on an AI/machine learning (ML)-based prediction of a particular event or measurements taking place in the future. A WTRU may be configured to determine at least one anticipated or predicted measurement and to evaluate the at least one predicted measurement relative to at least one trigger condition. In response to the predicted measurement satisfying the at least one trigger condition, the WTRU may generate a measurement report and may transmit the measurement report to a network node. The measurement report may comprise the at least one predicted measurement.

The triggers for the reporting of predictions may be network configured and may include several reporting options and times. A final reporting time may be a configured time before the predicted measurement event. The WTRU may receive configuration information. The configuration information may comprise information indicating the at least one triggering condition. The information indicating at least one trigger condition may comprise information indicating at least one reporting option and information indicating at least one reporting time. The information indicating at least one reporting time may comprise information indicating a length of time prior to the at least one predicted measurement.

A WTRU may be configured to perform filtering/averaging of predicted measurements consistent with configuration received from a network. Configuration information received by the WTRU may comprise information indicating that at least one reporting option may comprise information indicating a filter for predicted measurements. The WTRU may apply the filter for predicted measurements. The configuration information received by the WTRU may comprise information indicating at least one reporting option may comprise information indicating an average for predicted measurements. The WTRU may calculate the average for predicted future measurements.

A WTRU may be configured to trigger a measurement inference process multiple times and to collect prediction information that may be transmitted to the network. A WTRU may determine a plurality of predicted measurements across a time period. The WTRU may receive configuration information indicating a trigger for collecting predicted measurements. The WTRU may obtain the plurality of predicted measurements in response to determining a trigger has been satisfied. The WTRU may determine at least a first predicted measurement and a second predicted measurement during the time period. The first predicted measurement may be determined by performing inference at a first time during the time period and the second predicted measurement may be determined by performing inference at a second time during the timer period. The WTRU may generate a measurement report comprising at least the first predicted measurement and the second predicted measurement. The WTRU may send the measurement report to a network node. The WTRU may send the predicted measurement information at the last opportunity for the WTRU to report the predicted measurements.

A WTRU may be configured to obtain a plurality of ranges of predicted measurements across a time period. The WTRU may receive configuration information indicating a confidence value for each of the plurality of ranges of predicted measurements in the time period. The WTRU may determine at least a first range of predicted values associated with a first time in the time period and a second range of predicted values associated with a second time in the time period. The first range of predicted values may have a first associated confidence value and the second range of predicted values may have a second associated confidence value. If the first range of predicted values and associated first confidence value satisfy a threshold comparison, the WTRU may generate a measurement report comprising the first range of predicted values and associated first confidence value and may transmit the measurement report to a network node.

A WTRU may be configured to override sending the predicted measurement information based on the difference found between predictions and actual measured values. A WTRU may determine at least one predicted measurement and determine the at least one predicted measurement satisfies at least one trigger condition. The WTRU may determine a measured value and compare the at least one predicted measurement to the measured value. In response to a difference between the predicted measurement and the measured value, the WTRU may override sending the at least one predicted measurement.

Configuration information received by the WTRU may comprise information indicating a length of time prior to the at least one predicted measurement. The WTRU may override sending the at least one predicted measurement at a time corresponding to the length of time prior to the at least one predicted measurement.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts example measurement configuration processing.

FIG. 3 depicts example measurement report triggering events.

FIG. 4 depicts example occurrences of measurement reports during a period of time.

FIG. 5 depicts example measurement reporting of a WTRU traversing cell coverage areas.

FIG. 6 depicts example time series production for reference signal received power (RSRP).

FIG. 7 depicts an example timeline of events associated with prediction reporting.

FIG. 8 depicts an example one-time inference procedure window.

FIG. 9 depicts example periodic WTRU predictions with window re-use.

FIG. 10 depicts example periodic WTRU predictions with configured window settings.

FIG. 11 depicts example WTRU moving window inference processing with spacing and window re-use.

FIG. 12 depicts example WTRU moving window inference processing with configurable spacing and window.

FIG. 13 depicts example predicted boundaries based on a percentage confidence interval.

FIG. 14 depicts example signaling for WTRU measurement prediction reporting processing.

### DETAILED DESCRIPTION

A more detailed understanding may be had from the following description, given by way of example in conjunction with the accompanying drawings.

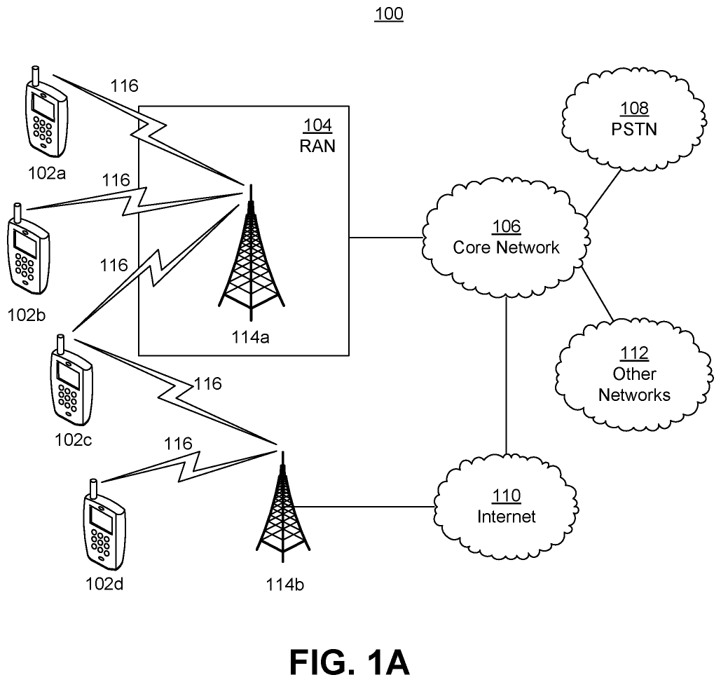

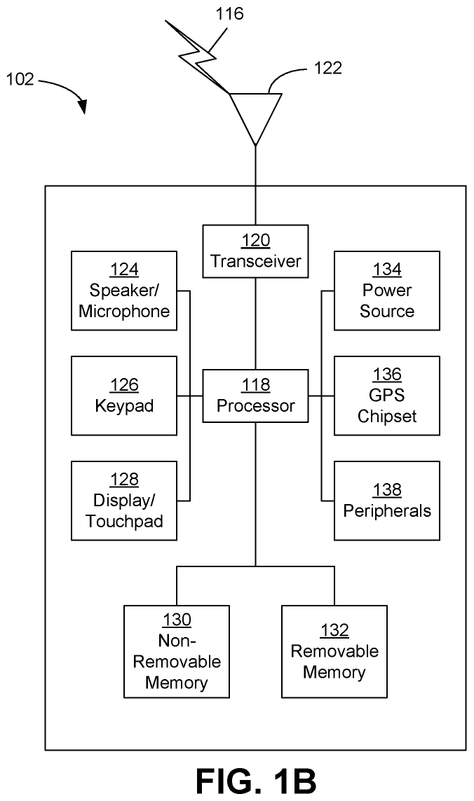

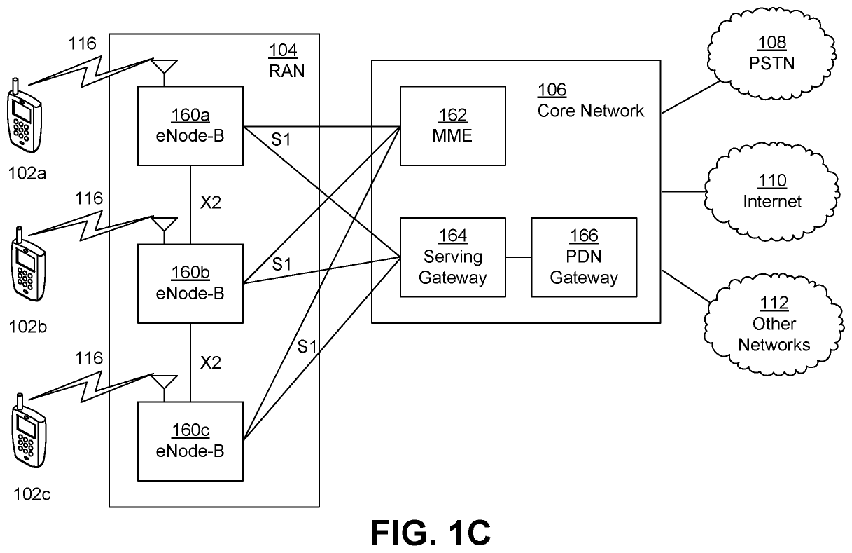

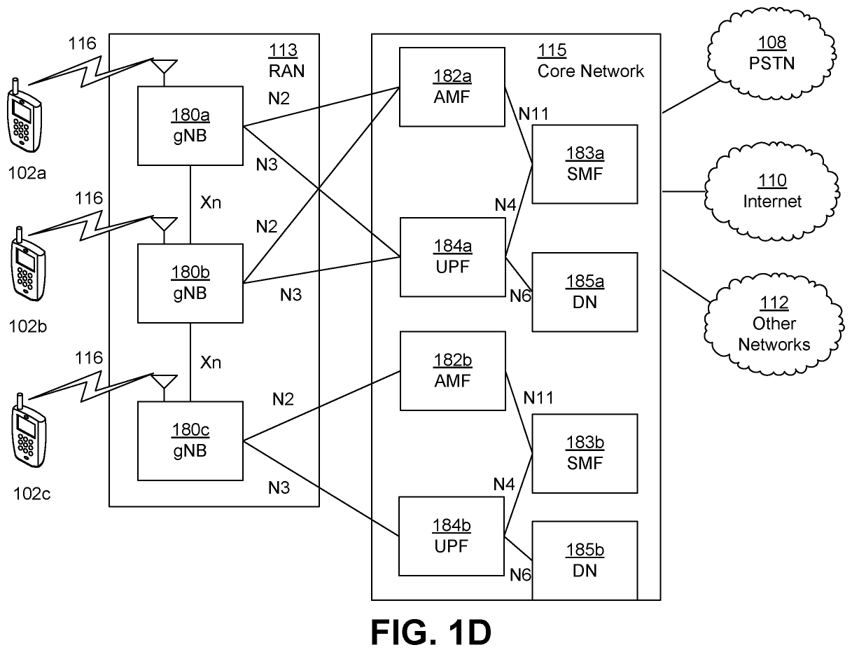

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform (DFT)-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode.

In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports (e.g., only supports) a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Implementations are disclosed for predicted measurements reporting. A WTRU may be configured to determine at least one predicted measurement. The at least one predicted measurement may comprise, for example, at least one predicted air interface measurement. The WTRU may determine, based on the at least one predicted measurement, a predicted event, and a predicted time associated with the predicted event and/or associated with the predicted measurement. The predicted event may comprise, for example, the at least one predicted measurement being less than a threshold. The WTRU may determine, based on the predicted event, the predicted time, and a time offset, to send a report indicating the predicted event. The WTRU may determine to send the report indicating the predicted event, for example, on a condition that a difference between a current time and the predicted time is greater than the time offset. If the condition is met, the WTU may send the report indicating the predicted event. The WTRU may be further configured to determine a predicted confidence associated with the predicted event. The report may comprise an indication of the predicted event, the at least one predicted measurement, and the predicted confidence.

Measurement reports may be generated periodically. A measurement report may be reported every x amount of time, where x refers to the reporting interval. Measurement reports may be event triggered. Based on a criterion that compares serving and/or neighbor cell signal levels to absolute or relative thresholds, e.g., A1-A6, events, a report may be triggered. Measurement reports may be reactive by design. A WTRU may perform measurements and report them to the network (NW) at specific report times or when a certain event criterion is triggered. The network may determine to perform an action based on the received measurements. For example, the network may send a handover command, may configure the WTRU with conditional HO (CHO), or may take some other action. Such a reactive handling of measurements may result in less than preferred processing. For example, a network may send HO instructions too late with the WTRU moving out of coverage of the serving cell after sending the measurements to the network but before receiving the HO command from the network. In the instance of a network orchestrating a CHO, unnecessary network resource utilization may result as the network may have reserved the resources of neighbor cells for a considerable time to prevent too late HOs.

Disclosed herein are methods to configure WTRUs to pre-emptively send measurement reports inferred from artificial intelligence (AI)/machine learning (ML) based prediction models. The measurement reports may allow the network to perform/prepare (e.g., pre-emptively and optimally perform/prepare) mobility procedures, allocate resources, activate other features, etc.

A WTRU, upon predicting that trigger conditions for a given measurement event may be fulfilled in the future, e.g., near future, may send a predictive measurement report. The measurement report may include predicted signal levels of serving and/or neighboring cells and other relevant details of an event such as, for example, a prediction time horizon, error of predictions, etc.

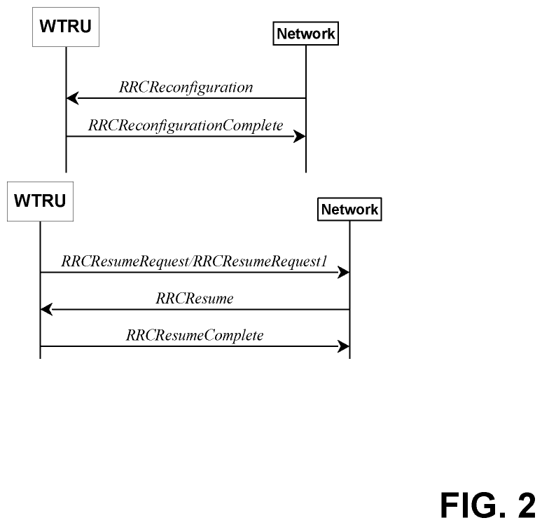

A WTRU may receive measurement configuration. The measurement configuration data may be received, for example, from a network node. FIG. 2 depicts example measurement configuration. A WTRU that may be in RRC_Connected mode may be configured by the network to perform measurements and to report them back to the network according to a configuration, e.g., a specific configuration. The configuration may be provided by means of dedicated signaling. For example, RRCReconfiguration or RRCResume may be used to provide configuration information to the WTRU.

The network may configure the WTRU to report the following measurement information based on SS/PBCH block(s): measurement results per SS/PBCH block; measurement results per cell based on SS/PBCH block(s); and/or SS/PBCH block(s) indexes.

The network may configure the WTRU to report the following measurement information based on CSI-RS resources: measurement results per CSI-RS resource; measurement results per cell based on CSI-RS resource(s); and/or CSI-RS resource measurement identifiers.

The network may configure the WTRU to perform the following types of measurements for NR sidelink and V2X sidelink: CBR measurements.

The network may configure the WTRU to report the following CLI measurement information based on SRS resources: measurement results per SRS resource; and/or SRS resource(s) indexes.

The network may configure the WTRU to report the following CLI measurement information based on CLI-RSSI resources: measurement results per CLI-RSSI resource; and/or CLI-RSSI resource(s) indexes.

A WTRU may be configured with information defining aspects of reporting of measurements. The WTRU may be configured with information that may define what, how, and when the WTRU may report information to a network node. The configuration information, which may be referred to as a measurement reporting configuration, may comprise the following: reporting criterion; RS type; and/or reporting format. The reporting criterion may be a criterion that triggers the WTRU to send a measurement report. The criterion may define a periodic trigger and/or a single event trigger description. RS type may be the reference signal (RS) that the WTRU uses for beam and cell measurement results. The RS type may be, for example, SS/PBCH block and/or CSI-RS. The reporting format may comprise the quantities per cell and per beam that the WTRU may include in the measurement report (e.g., RSRP) and other associated information such as, for example, the maximum number of cells and the maximum number beams per cell to report.

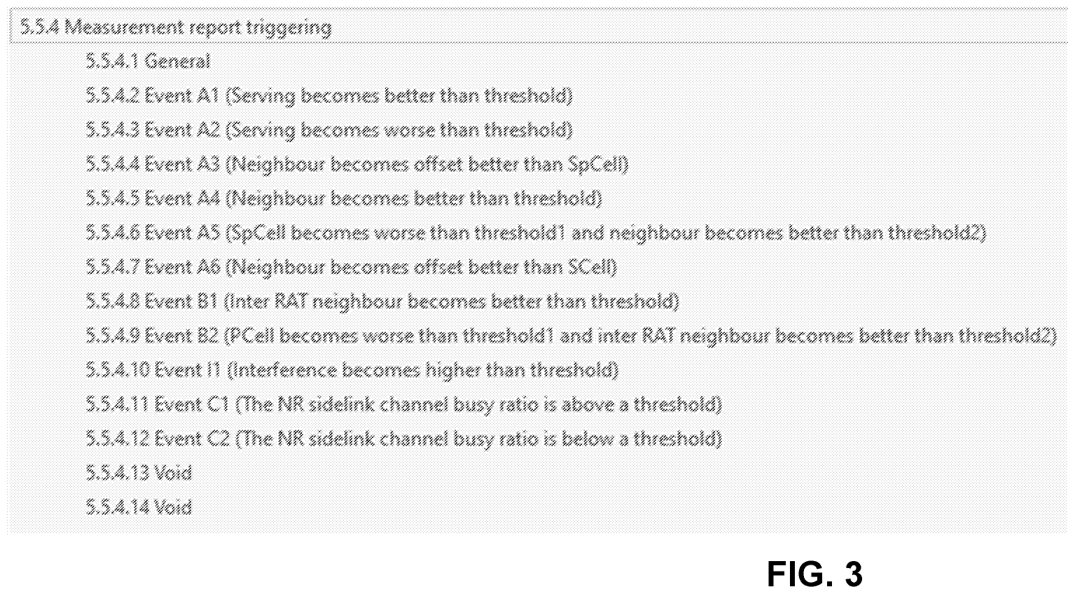

WTRU measurement reporting may be configured by the network to be triggered based, for example, on one or more of the following: periodic reporting and/or event-triggered. With respect to periodic reporting, a report interval may be designated as follows: ReportInterval::=ENUMERATED {ms120, ms240, ms480, ms640, ms1024, ms2048, ms5120, ms10240, ms20480, ms40960, min1, min6, min12, min30}. With respect to event-triggered reporting, a report interval may be designated as follows: ReportInterval::=ENUMERATED {ms120, ms240, ms480, ms640, msl024, ms2048, ms5120, ms10240, ms20480, ms40960, min1, min6, min12, min30}. Event-triggered reporting may further rely upon criteria for triggering a report. The criteria for triggering a report may comprise the occurrence of events in the network. FIG. 3 depicts example measurement report triggering events. A WTRU may be configured with information specifying triggering events such as, for example, those depicted in FIG. 3.

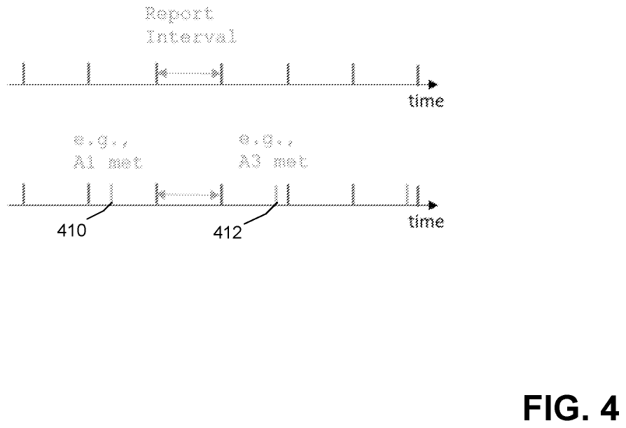

A measurement report may be triggered in response to, for example, event criteria having been met. For example, the occurrence of event A3 as depicted in FIG. 3 (e.g., a neighbor becomes offset better than SPCell) may trigger generation of a measurement report. A measurement report may be triggered in response to the ReportInterval time quantity having expired. FIG. 4 illustrates example occurrences of measurement reports during a period of time. Each vertical line on the time continuum may correspond to generation of a measurement report. The vertical marks on the upper timeline, e.g., the purple vertical marks, represent periodic measurement reports. As noted in FIG. 4, the time between the occurrence of measurement reports may be referred to as a report interval. Referring to the lower timeline in FIG. 4, vertical mark, e.g., green vertical mark, 410 may correspond to an event trigger report, which may have been triggered by, for example, the occurrence of event 1 of FIG. 3. Vertical mark, e.g., green vertical mark, 412 may correspond to a second event trigger which may be, for example, the occurrence of event A3 of FIG. 3.

A WTRU may be configured to perform layer 3 filtering. As a WTRU measures the air interface, whether it may be measuring cell, beam, and/or sidelink, and whether it may be measuring RSRP, RSRQ, and/or SINR quantities, the WTRU may use the following formula to average the received measurement data points from the physical layer for evaluation of measurement report triggering:

$${F}_{n} = ( 1 - a ) * {F}_{n - 1} + a * {M}_{n}$$

In this formula, Mₙ may be the latest received measurement result from the physical layer. Fₙ may be the updated filtered measurement result that may be used for evaluation of reporting criteria or for measurement reporting. Fₙ₋₁ may be the old filtered measurement result, where F₀ may be set to M₁ when the first measurement result from the physical layer may be received; and for MeasObjectNR, a=1/2^{(k/4)}, where kᵢ may be the filterCoefficient for the corresponding measurement quantity of the i:th QuantityConfigNR in quantityConfigNR-List, and i may be indicated by quantityConfig/ndex in MeasObjectNR; for other measurements, a=1/2^{(k/4)}, where k may be thefilterCoefficient for the corresponding measurement quantity received by the quantityConfig; for UTRA-FDD, a=1/2^{(k/4)}, where k may be the filterCoefficient for the corresponding measurement quantity received by quantityConfigUTRA-FDD in the QuantityConfig.

Mₙ may correspond to a measurement data point that may be plugged into the formula influenced by weight parameter a. This may be done to avoid situations where a spike in the value of the latest measurement may significantly change the value of Fₙ.

Fₙ may represent the average measurement value for any of the measured quantities (RSRP, RSRQ, SINR) that may be evaluated for the purpose of triggering a measurement report to the gNB or to validate that the conditional reconfiguration configurations are met. Parameters nrofSS-BlocksToAverage and nrofCSI-RS-ResourcesToAverage may define the number of samples (F₂, F₃, F₄, F₅ . . . , Fₘₐₓ) the WTRU averages before evaluating/validating measurement report and conditional reconfiguration triggers.

The presented IEs, e.g., all of the presented IEs, may be passed from the gNB to the WTRU via an RRC Reconfiguration message. With the described information, the WTRU may have the information, e.g., all of the information, required from a time domain perspective to perform measurements as defined by the gNB.

The WTRU may measure the air interface using the SMTC window configuration. It may sample the air interface every x ms according to this configuration. The parameters nrofSS-BlocksToAverage and nrofCSI-RS-ResourcesToAverage may be used by the WTRU to choose how many of those samples will be used in the averaging process before delivering a result to the network.

The machine learning (“ML”) models employed to generate predictions may have embedded statistical aspects. The estimation accuracy of machine learning models may vary depending upon the time horizon associated with the generated prediction. A machine learning model may be able, amongst other functions, to forecast or to predict future values of a given quantity. The prediction may have a timestamp value associated with it. Predicted values may have an associated timestamp and/or a small interval (e.g., a few ms) during which the predicted value may be considered valid. The timestamp may be generalized as a future time step. With each predicted value, there may be (e.g., may always be) an estimation of the error or deviation associated with the predicted value. This error may be calculated recursively and the longer the time horizon associated with the prediction, the less accurate, e.g., worse, the estimation may be expected to be. A machine learning model outputting sample at a time step of t+4, for example, may have an estimated value of a sample/prediction and an estimation of the error that may be more accurate than an estimated value of the prediction and error estimation at a later time such as, for example, t+7.

In predictive inference, a prediction interval may be an estimate of an interval in which a future observation may fall with a certain probability given what may have been observed. A machine learning model may output an interval based on an associated probability P. If a probability may be P=0.95 or 95%, then a model may output a window of values where it may be estimated that a predicted value for any future time step may fall within the given window with the particular probability, e.g., 95%. Different values for a confidence probability may cause a machine learning model to generate different prediction windows.

With AI/ML techniques, network configured events may be predicted at the WTRU. However, with legacy mechanisms, the network may not receive this predicted information beforehand and may not be able to leverage the anticipated knowledge of the event.

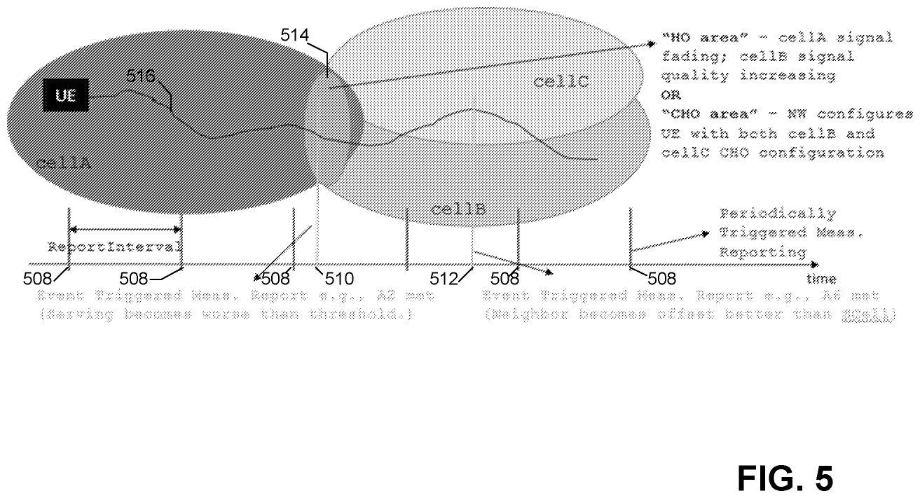

FIG. 5 illustrates example measurement reporting by a WTRU as it moves through multiple cell coverage areas. In the depicted example, the WTRU may generate reports as it moves through a handover area (“HO area”) and a conditional handover area (“CHO area”). A WTRU in mobility across the coverage of three cells is shown for illustrative purposes. Referring to FIG. 5, a WTRU in mobility may be designated as UE. A trajectory followed by the WTRU may be marked by a black line 516. The WTRU may be illustrated moving in coverage of cellA, cellB and cellC, the coverage area of each of which may be depicted using ovals. A “handover (HO) area,” which may be marked by an ellipse 514, e.g., orange ellipse, occurs where there may be overlapping coverage of cells A and B. In the HO area, following the WTRUs trajectory, the signals from cell A may decrease in power and the signals from cell B may increase in power. In this area, WTRUs may also receive a conditional handover (CHO) configuration because the network may be uncertain of which cells—either B or C—may be best for the WTRU.

FIG. 5 also depicts a timeline. The timeline indicates instances that measurement reports may be generated. Periodic measurement reports may be represented on the timeline with vertical marks 508, which may be purple marks. The periodic measurement reports represented by vertical marks 508 may be sent by the WTRU at “ReportInterval” time intervals. Event triggered measurement reports may be represented at vertical marks 510 and 512, which may be green marks. The WTRU may send an event triggered measurement report when a network configured event may be detected by the WTRU.

Measurement reporting methods may be reactive which may result in delayed processing by the network as illustrated from the processing associated with the “HO area” and the “CHO area”. With respect to movement of the WTRU through the HO area, the WTRU may trigger a measurement report message with measurement information upon the detection of an event. Based on the received measurement report, the network may take some action such as, for example, communicating a handover command. However, because the network may not send the handover command and the WTRU may not receive the handover command until WTRU may be substantially through the HO area, it may be too late for the network to send the command, e.g., for the WTRU to connect to another cell. In such a scenario, the network may configure the WTRU with CHO configuration, providing the WTRU with two cell options to handover to, cells B and C. This may result in a longer WTRU configuration and longer resource reservation for the network nodes that radiate these cells.

Leveraging AI/ML techniques, models may be trained to predict measurements and, consequently, to predict network configured events. Methods to enable the network to receive predicted events before the WTRU actually experiences the events may be desirable and may enable the network to act proactively and prevent service disruption.

A WTRU may be configured to make predictions. The WTRU may be pre-trained with an AI/ML model that may be able to produce predictions of air-interface measurements (RSRP, RSRQ, SINR, etc.) of serving and/or neighbor cells. The predictions may be compared to measurement triggering conditions. The WTRU may send the measurement reports when the AI/ML models indicate triggering conditions may be fulfilled in the near future.

Disclosed herein are implementations for a WTRU to report predicted measurements upon detecting that triggering conditions for reporting configuration measurements are expected to be fulfilled in the future. The network may receive the predicted measurements and take any suitable action based on anticipation of certain measurements.

The WTRU may receive configuration data that enables the WTRU to trigger reports of measurements with the predicted information. The report with predicted information may be generated prior to reporting employed in other measurement reporting procedures. The WTRU may receive configuration of how to perform predictions, how to re-use or not re-use the configuration, and how to report back to the network. When the configured conditions are met, the WTRU may send the prediction related information to the network, anticipating the event, and thus providing time for the network to take related relevant actions.

A WTRU may be configured to predict future measurements based on current and/or historical measurements. The WTRU may be configured with a trained AI/ML model that may be able to produce predictions for radio interface radio signal levels. The AI/ML model at the WTRU may be implementation based. The AI/ML model at the WTRU may obtain the AI/ML model from the network. The AI/ML model may be configured to take as an input current and/or historical RSRP measurements. The AI/ML model may be configured to take additional inputs such as WTRU location information, WTRU mobility information, etc. The AI/ML model may be configured to produce single value predictions, e.g., RSRP, at a future time instant t. The AI/ML model may be configured to predict a series of RSRP values corresponding to future time instances t+1, t+2 so on up to t+n. Prediction with time series output may be more beneficial than single value predictions as it may be difficult to match the prediction with a configured measured event with a single prediction point.

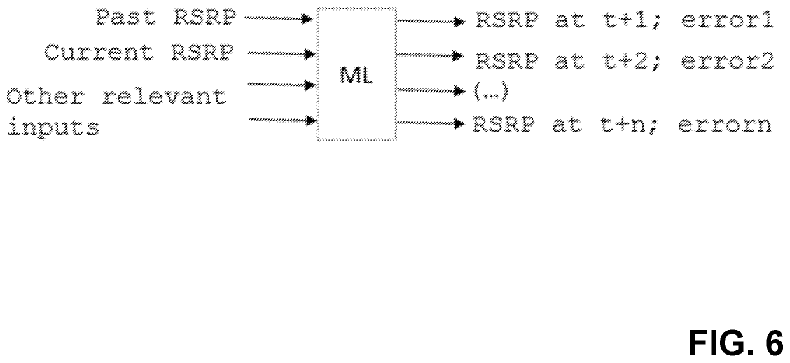

To produce meaningful predictions, or predictions that may be of use, the WTRU may make the predictions in a time series manner. From the moment that WTRU predictions are triggered, the WTRU may produce several prediction outputs over a future time span, with a certain granularity or time step. FIG. 6 depicts an example time series production for reference signal received power (RSRP). Referring to FIG. 6, at time t, the WTRU may predict one RSRP prediction point per time step from time t+1 until t+n.

A WTRU may be configured to perform prediction and generate predicted values. Predicted values may have an associated timestamp and/or a small interval (e.g., a few ms) during which the predicted value may be considered valid. For each prediction point, at each time step, there may be an error value associated with the prediction. The error value may comprise an error, estimated error, confidence indication, estimated confidence, accuracy, estimated accuracy, and/or any other error measurement technique. This may be intrinsic to ML algorithms. The further away in time that the predictions are made (e.g., the longer the value of n), the higher the error of the prediction may be. It may be appropriate to define a duration, e.g., a maximum duration, of the time span of the predictions (e.g., value of n time steps) that may be defined in various forms including the following: a number of time steps (e.g., a value for n); the granularity between time steps (e.g., a time value between each prediction point); and/or a threshold for the error of the prediction.

An AI/ML model that resides at the WTRU may have been delivered by the network and, therefore, the network may have access to intrinsic characteristics, e.g., all model intrinsic characteristics. Accordingly, the network may be able to configure the WTRU with suitable, e.g., necessary, parametrization. This may be done, for example, at the time that the model may be delivered to the WTRU or at any point in time via any message or SIB broadcasting after the model may be delivered. A group of AI/ML models may have been delivered to the WTRU, in which case the network may provide the WTRU with the relevant information for model selection, e.g., via a model ID.

Another option for the origin of the AI/ML model may be that it may be proprietary and vendor specific and may already be available at the WTRU. The WTRU may signal its model capabilities to the network, so that the network may take the WTRU capabilities into account when configuring the WTRU and/or may allow the WTRU to decide which set of parameters to use.

In connection with measuring an air interface, the WTRU may use the parameters nrofSS-BlocksToAverage and nrofCSI-RS-ResourcesToAverage to choose how many of the samples may be used in the averaging process before delivering a result to the network.

Considering a prediction time span of size n (e.g., with n time steps), predicting samples at the same rate as the SMTC window (e.g., finest granularity, every 5 ms) may make the inference process computationally more intense because it may reduce the actual time length of n. Increasing it too much may lead to a longer n time window, but may impact, e.g., greatly impact, the error associated with the predictions, especially towards the end of the time window.

When the WTRU may be configured to perform predictions, the prediction granularity may take the averaging process into account.

The WTRU may be configured to use parameters nrofSS-BlocksToAverage and/or nrofCSI-RS-ResourcesToAverage (e.g., which may be either explicitly configured or fixed in a standard) as the parameter that defines the timestep granularity of the predictions.

The WTRU may be configured to use different averaging parameters for predicted measurements as compared to normal measurements. The WTRU may be configured to use, for example, nrofSS-BlocksToAverage=n1 for normal measurements and nrofSS-BlocksToAverage=n2 for predicted measurements.

The WTRU may be configured to use different granularities for time steps configured for different parts of the window (t;t+n), e.g., 4 samples in (t; t+x) and 2 in (t+x; t+n). This option may be relevant to taking into account that the error of a prediction may be likely to be higher towards the end of the window (e.g., time step n). For this reason, the network may configure different averaging numbers of samples in an attempt to make the last sample less significant to the final result.

The WTRU may be configured to use different granularities for the time steps configured for different parts of the window (e.g., t;t+n), according to different rates of changes for each sample, e.g., 2 samples in (e.g., t; t+x, where the change rate in this sub-window may be higher) and 4 in (e.g., t+x; t+n, where the change rate in this window may be lower).

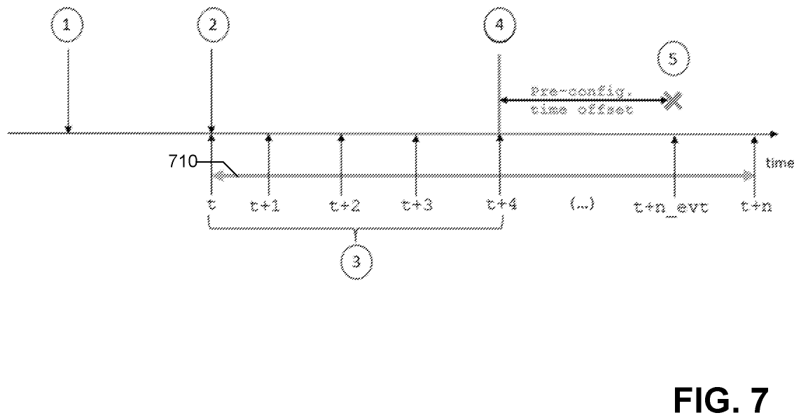

A WTRU may be configured to perform prediction reporting. FIG. 7 depicts a timeline showing example WTRU predictions and reporting. Referring to FIG. 7, reference numbers 1-5 are shown on the timeline and may correspond to events and/or processing. At time t, the WTRU may perform AI/ML inference and produce predictions for the air interface measurements in a time series manner. The WTRU may generate a prediction estimate and an associated error for time t+1, another at time t+2, etc., where each time may comprise a time interval. At t+n_evt, n_evt time steps after the predictions are produced, the WTRU may predict that the triggering conditions for predicted measurement reporting may be fulfilled. As an example, the WTRU may be configured with an A2 event or event similar to A2, e.g., predEventA2 (during which a serving cell may be expected to become worse than a threshold) for a particular cell.

The WTRU may be configured to send the prediction related information before t+n_evt. The amount of time before t+n_evt that the WTRU sends the prediction related information may be configurable and may correspond to the “pre-configured time offset” depicted in FIG. 7. The bi-directional arrow 710, e.g., green bi-directional arrow, in FIG. 7 may represent the time span over which the inference/predictions may be made. If the WTRU triggers predictions at time t, the WTRU may generate n prediction points, spaced by a timestep value or granularity, until time t+n. The green arrow 710 may represent the time span from t until t+n.

Referring to FIG. 7, at reference number 1, the WTRU may indicate prediction capabilities to the network. These capabilities may be intrinsic to the AI/ML model used by the WTRU and may include parameters, for example, as described herein.

Referring to FIG. 7, at reference number 2, which corresponds to time t, the WTRU may, if the model output predictions are configured by the network, receive an inference configuration. The configuration may be fixed fully or partially, e.g., by a standard, or may include parameters and a particular occasion for the WTRU to trigger the inference/predictions. The trigger may be configured by the network so as to have some limitations on the area/location/time of day that the prediction measurements may be sent or that WTRU measurement prediction and reporting may be active.

Specific air interface measurement quantities may be used to trigger the predictions. If specific air interface measurement quantities may be used to trigger predictions, the configuration may comprise, for example, the following: a particular cell that the WTRU may be able to detect (e.g., trigger predictions if cell X may be detected via measurements); a list of cells that the WTRU may be able to detect (e.g., trigger predictions if cells, e.g., all cells, in given set of cells are detected via measurements); a specific value for an air interface measurement quantity for a particular cell (e.g., RSRQ may be below threshold for celllD=x); a specific value for an air interface measurement quantity for a set of cells (e.g., RSRQ may be below threshold for cells, e.g., all cells, in a given set of cells or SINR may be below threshold for celllD=x and RSRP may be higher than threshold for celllD=y); an interval for a specific air interface measurement quantity for a particular cell (e.g., a<=RSRP<=b for celllD=X); different intervals for a specific air interface measurement quantity for a group of cells (e.g., a<=RSRP<=b for celllD=X AND c<=RSRP<=d for celllD=Y); a particular beam level that the WTRU may be able to detect (e.g., trigger predictions if beam level X may be detected via measurements); a list of beam levels that the WTRU may be able to detect (e.g., trigger predictions if beam levels, e.g., all beam levels, in a given set of beam levels are detected via measurements); a specific value for an air interface measurement quantity for a particular beam level; a specific value for an air interface measurement quantity for a set of beam levels; and other triggers which may be similar to existing triggers in measurement procedures, that compare quality of a measurement to a threshold, or that compare quality between cells. Other triggers may comprise, for example, the following: immediate trigger of predictions; a specific timestamp to trigger the predictions; a timer to trigger the predictions wherein the timer counts from the timestamp when the configuration may have been received; a specific geo-location to trigger the predictions; and/or a specific geo-area to trigger the predictions.

The WTRU may perform inference at time t (e.g., immediately upon configuration reception) and until t+n. The WTRU may have acquired an estimate value for a prediction point (e.g., where point may refer to time only as the model may output RSRP and RSRQ at the same time for time steps, e.g., all the time steps) at t+1, t+2, ( . . . ), t+n_evt, t+n. The WTRU may have predicted that the air interface quantity may be such that the measurement event, e.g., legacy configured measurement event, may happen at t+n_evt, n_evt time steps after the predictions were triggered.

As the WTRU may have predicted a network configured event, the WTRU may report the predictions immediately (if the WTRU may be instructed it to do so) or it may report the predictions using the next periodic measurement report (as per measurement configuration from the network that may have been received prior to the predictions triggering). The WTRU may keep the measurement predictions without sending and may wait for time t+4 corresponding to reference number 4 in the timeline of FIG. 7 where the predictions may be sent regardless before the event, e.g., t+n_evt, actually takes place.

Referring to reference number 3 in FIG. 7, at time t, the WTRU may predict the occurrence of a measurement at time t+n_evt. The timestep n_evt represents a time that may be near the end of the predictions/inference window, of size n timesteps. Due to the nature of AI/ML algorithms, the further away in time that the predictions may be made (e.g., the longer the value of n), the higher the error of the prediction may be. The prediction at time n_evt may be likely, e.g., may be highly likely, to have a higher error value than a prediction made for time t+1 or t+2. For this reason, the WTRU may have options to re-run the inference process at any point in time before the last opportunity to send the predictions, e.g., at the time corresponding to reference number 4 of the timeline. The WTRU may be configured with different options for inference re-running between time t and time t+4, for example. One option for inference re-running may be the WTRU triggering inference re-run at every time step until the time corresponding to reference number 4. The WTRU may trigger inference re-run at a specific time step or time steps. The WTRU may trigger inference re-run for a delta number of timesteps since the first event prediction.

The WTRU re-running the inference process may be an extra computational burden that may be mitigated by configuration. If the inference re-run may be triggered at time t+2, the WTRU may perform, for example, one or more of the following: re-run inference until, e.g., only until, the initial time the event was first predicted, t_evt; re-run inference using the same time span (e.g., if the WTRU re-runs inference at t+2, it may predict values until t+n+2); and/or re-run inference until the event may be predicted again, it being at time t_evt or other later or earlier time (as a result of a new prediction).

If the inference may be executed multiple times, there may be multiple prediction values and associated errors for each time step. The WTRU may be configured, during this window and before time corresponding to reference number 4, to transmit the prediction values using a legacy measurement report or using other configurable options. If there may be one, e.g., only one, periodic measurement report (based on the measurement configuration), the WTRU may send predictions, e.g., all predictions, and error values for time steps, e.g., all time steps, resulting from the inference executions, e.g., all of the inference executions. If there may be one, e.g., only one, periodic measurement report (based on the measurement configuration), the WTRU may send the predictions, e.g., all the predictions, for a subset of specific time steps (e.g., x time steps before reference number 4). If there may be one, e.g., only one, periodic measurement report (based on the measurement configuration), the WTRU may send a subset of the predictions for time steps, e.g., all time steps (e.g., send, e.g., send only, the prediction corresponding to the lowest error or send only predictions whose error falls below a threshold). If there may be one, e.g., only one, periodic measurement report (based on the measurement configuration), the WTRU may send a subset of the predictions for specific time steps (e.g., send, e.g., send only, the prediction corresponding to the lowest error or send, e.g., send only, predictions whose error falls below a threshold, but this time only for specific time steps). If there are multiple periodic measurement reports in the window, the WTRU may transmit the prediction values to the network and spread the results over the multiple measurement reports (e.g., send the predictions for a delta number of time steps closer to the latest t_evt in the first measurement report, then another delta number of time steps before that in the next measurement report).

Referring to FIG. 7, at reference number 4, the WTRU may trigger an anticipated or predicted measurement report at a time interval of “Pre-config. time offset” before a predicted event. The network may configure the WTRU with one or more of the following: a) a pre-configured time offset counted from the timestamp of the predicted event (reference number 5); b) a geo-location associated with a geographical distance of t_evt; c) a distance from t_evt; d) a number of predictions where at t_evt, the WTRU has predicted the event will happen (e.g., after 5 predictions, event happens at t_evt, send the predictions); e) an amount of UL and/or DL; f) an air interface radio quantity drop/increase delta, e.g., RSRP delta; g) a number of predictions where at t_evt, the WTRU has predicted the event will happen with a certain error lower/higher than a threshold (e.g., after 5 predictions, event happens at t_evt, with a certain error value under a threshold, then send the predictions); h) items d or g but considering consecutive predictions; and/or i) the pre-configured time offset may be associated with the other options (e.g., if items d, g, or h occur before pre-configured time offset, the WTRU may send predictions; otherwise, the WTRU may send predictions at the pre-configured time offset regardless of whether other criteria may be met).

The time corresponding to reference number 4 may be considered the last opportunity for the WTRU to send the predicted measurements information to the network. Thereafter, due to the latency of a WTRU-network message, the anticipation of the procedure may not make sense as it may be too late, and the desired outcome may not result. The WTRU may override the transmission of the predictions based on one or more conditions that may be configured by the network. The one or more conditions may comprise, for example, one or more of the following: the WTRU may not send the predictions based on a state transition change; the WTRU may not send the predictions based on set of detectable cells changes; the WTRU may not send the predictions based on set of configured measurement cells changes; the WTRU may not send the predictions based on error of the predictions not meeting triggering criteria (e.g., configuration item g above); and/or the WTRU may not send the predictions based on having the predicted measurement value fall outside of the triggering conditions when the inference may be re-run.

Referring to FIG. 7, reference number 5 corresponds to the time at which the WTRU may have predicted a certain event may happen. It may be marked at time t_evt but it may be considered that t_evt may change every time the WTRU performs inference. Hence, the configuration options discussed herein in connection with reference numbers 3 and 4 of FIG. 7.

There may be a number of options for how to define signaling to configure reporting and actually reporting predicted measurements. The function to predict measurements may be embedded in the existing WTRU measurement procedures. This may be a default option. There may be a separate predicted measurement procedure that may have the same structure as the existing measurement procedure with all or of a subset of the existing events or new defined events in the new measurement prediction procedure. Another existing or new procedure may be defined that allows for configuration and reporting of events. In any of these options, the procedure may configure the measurement parameters, e.g., all of the measurement parameters, for the calculation of the predicted measurements or some or all of the parameters may be fixed values, and other aspects of measurements like layer 3 filtering may or may not apply.

The processing described herein applies in a similar way for the case where the predicted events are configured and reported in the existing measurement procedures, in a predicted measurement procedure modelled after the existing measurement procedures, or imbedded in other existing or new procedures.

Prediction reporting may be employed to detect an event and inference processing may be re-run to detect that particular event, e.g., to confirm or reassess the previous prediction. A WTRU may receive a configuration that allows the WTRU to use the event detection and inference processing multiple times if required.

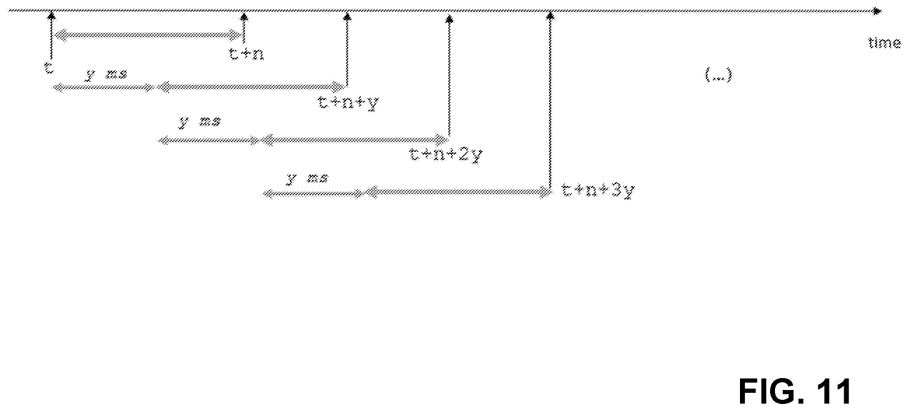

The WTRU may be configured to execute the inference procedure once. The WTRU may be configured to execute the inference process periodically. The WTRU may be configured to trigger the inference process in a moving window manner as described, for example, in connection with FIG. 11.

The WTRU may be configured with different procedural options for re-use for different cells according to network requests and/or needs. The WTRU may be configured to perform one or more of the following: execute the procedure once for a particular cell; execute the procedure once for a set of cells; execute the procedure once for cells, e.g., all cells, in the measurement configuration; and/or execute the procedure once for detectable cells, e.g., all detectable cells.

The WTRU may be configured with different options relating to the recurrent inference procedure. The WTRU may be configured to perform one or more of the following: execute the procedure recurrently for a particular cell; execute the procedure recurrently for a set of cells; execute the procedure recurrently for cells, e.g., all cells, in the measurement configuration; and/or execute the procedure recurrently for detectable cells, e.g., all detectable cells.

The WTRU may be configured with different options relating to the moving window procedure. The WTRU may be configured to perform one or more of the following: execute the moving window procedure for a particular cell; execute the moving window procedure for a set of cells; execute the moving window procedure for cells, e.g., all cells, in the measurement configuration; and/or execute the moving window procedure for detectable cells, e.g., all detectable cells.

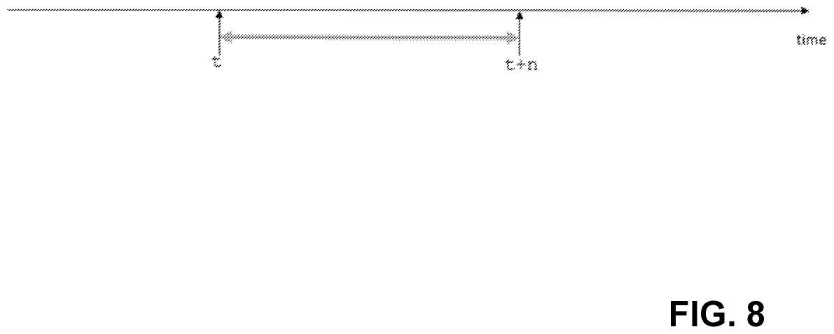

A WTRU may be configured to perform a one-time inference procedure. The WTRU may execute the inference procedure once, e.g., only once. FIG. 8 depicts an example one time inference procedure window. As shown, the time inference procedure window may be straightforward and may comprise a period between t and t+n.

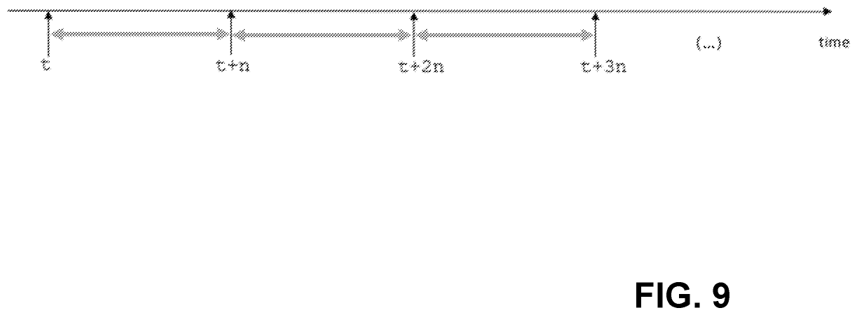

A WTRU may be configured to perform a recurrent inference procedure. The WTRU may perform recurrent inference procedures based on network configuration and/or based on fixed, e.g., standard defined, forms or configurations. FIG. 9 depicts example periodic WTRU predictions with window re-use. As shown, for a particular cell, the WTRU may be configured with a value for n and periodically trigger predictions at multiples of n.

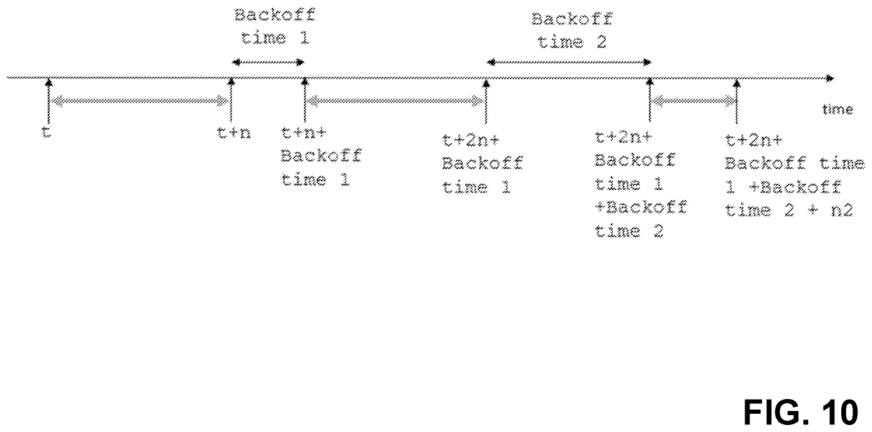

In connection with performing recurrent inference processing, the WTRU may be configured with one or more backoff timers. These timers may cause the TRU to refrain from performing inference for a certain amount of time. The network may have an estimate of when WTRU prediction support may be required and may, in this way, limit the WTRU's battery and computational resources usage. FIG. 10 depicts example periodic WTRU predictions with configured window settings. As shown in FIG. 10, different backoff timers may be set before the WTRU performs inference and when this happens, the WTRU may be configured with windows of different sizes (n, n2, etc.).

A WTRU may be configured to perform moving window inference procedures. The WTRU may perform inference in a moving window manner. The WTRU may be configured, e.g., specially configured, to perform moving window processing and/or the WTRU may be configured to perform moving window processing as defined, e.g., fixed, in a standard. Multiple, e.g., two, example approaches may be performed. FIG. 11 illustrates example WTRU moving window inference processing with spacing and window re-use. There may be a fixed spacing configuration, y, after which the WTRU (starting from time t) may re-run the inference process. The inference process window may be of fixed size n.

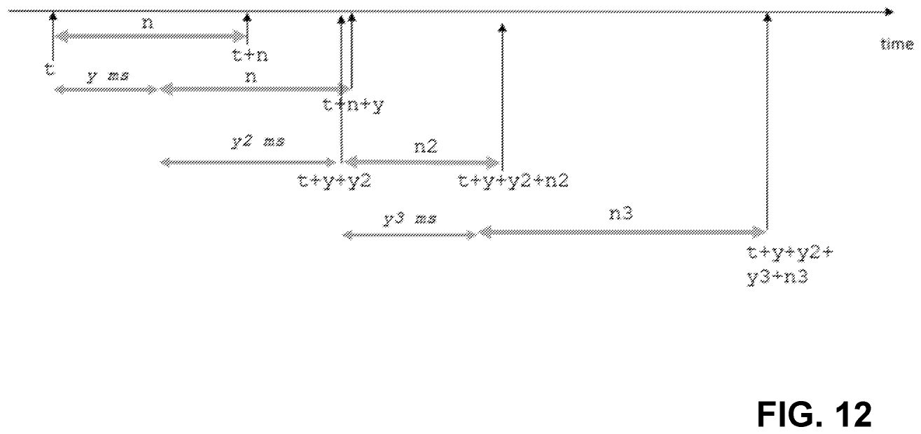

In an example approach, both the spacing, y, and the time span of the predictions, n, may be configured for different values. FIG. 12 illustrates example WTRU moving window inference processing with configurable spacing and window. Such processing may be useful in cases where the network may take into account internal predictions and estimates, for example, that an event might occur around time n. The WTRU may execute inference until t+n. If no event is predicted, the WTRU may re-run inference at time t+y. If an event is predicted, the WTRU may re-run inference at time t+y so that the newer predictions have lower associated error.

The network may have prediction results that conclude no events will happen around time t+n+y. For this reason, it may be beneficial to spare the WTRU from extra computations and introduce y2 with a high confidence that the likelihood of an event may be low, e.g., very low.

A WTRU may be configured to allow for the possibility to adjust the inference window by tuning n (e.g., n, n2, n3, etc.). The longer the window, the higher the errors associated with predictions may be. The likelihood of the WTRU experiencing a configured measurement event may be used to tune the value of n for different occasions. The window may be longer if the network may be confident that there will be no event detected or predicted. The window may be shorter otherwise.

A WTRU may be configured to employ prediction intervals. An AI/ML model may be implementation or vendor specific, or may be fetched by a WTRU from the network and/or delivered by the network to the WTRU. If the AI/ML model may be implementation or vendor specific, the prediction interval and the time span of prediction-related capability exchanges may become relevant. This may also apply, e.g., apply equally, if the AI/ML model is received from the network because using the same trained model may or may not be suitable to generate predictions for the same WTRU under different circumstances.

In connection with prediction-related capability exchanges, the WTRU may signal to the network time values and/or ranges representing a duration for predicted values during which the prediction windows may or may not be larger than a certain threshold. For example, the prediction values may be sufficiently accurate and not within an unreasonable range, e.g., a reasonable range of 95<RSRP<−97 rather than −95<RSRP<−120, for the same confidence percentage, e.g., 0.95 or 95%. The threshold may be communicated to the WTRU in network signaling configuration information and/or may be broadcasted over SIB.

Estimates/predictions may become less accurate over time. The estimates may be higher in the beginning, may become lower, and may become higher again. The changes in estimates may relate to the quality of the data used to train a model, where more data points may have been available for training under particular circumstances. If subsequently, when performing inference, the model may see as input data that falls under the same or similar circumstances, it may output a prediction within a smaller range again. For this reason, the information that the WTRU may signal to the network, as referenced above, may come in the form of value(s) or range(s).

Employing prediction intervals may involve adding to the WTRU configuration information, additional information for generating predictions that may be delivered to the network as part of the capability exchange, e.g., in anticipated measurement reports. The additional configuration information may comprise, for example, information associated with prediction intervals and percentage confidences related to the intervals. The WTRU may employ the configuration information to determine predicted values within prediction intervals having associated percentage confidence values.

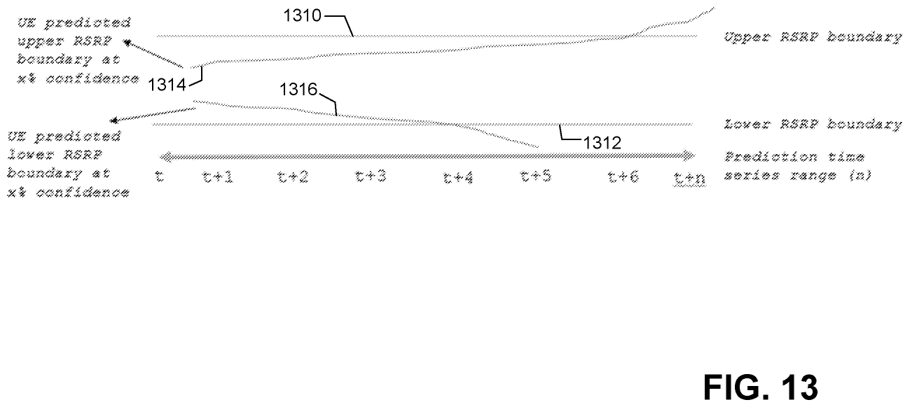

FIG. 13 illustrates an example implementation of prediction intervals. In FIG. 13, RSRP boundaries based on a percentage (x %) confidence interval are depicted. An upper RSRP boundary for a given interval is depicted by line 1310 and a lower RSRP boundary for the interval is depicted by line 1312. Line 1314 depicts a WTRU predicted upper RSPR boundary at a defined percentage (x %) confidence level across a time series range t through t+n. Line 1316 depicts a WTRU predicted lower RSRP boundary at a defined percentage (x %) confidence level across a time series range t through t+n. As shown, line 1314 depicting a predicted upper RSPR boundary at a percentage confidence level and line 1316 depicting a lower RSRP boundary at a percentage confidence level change due to estimation variability over time.

FIG. 13 depicts an example illustrating how prediction boundaries (confidence intervals) may either remain fixed over time (as depicted by lines 1310 and 1312) or they may change (as depicted by lines 1314 and 1316). The upper and lower boundaries may become further separated as the boundaries may change differently over time. The time scale may be generic and may be represented over a number of time slots, from t to t+n.

The use of confidence levels in generating AI/ML results may impact the processing and results.

As explained herein, a network may configure a WTRU to produce a range of values, e.g., a range of RSRP values, for each timestep, for any one of the timesteps, and/or for any subset of timesteps within a range of a prediction window. If a WTRU may be configured to generate a range of predictions based on a confidence value, the values may be different for each timestep.

As explained herein, a WTRU may be configured with a parameterization. The configuration information may be adapted to account for confidence values. A network may configure a WTRU with different values for the confidence value of predictions for each timestep if a range of prediction values apply.

As explained herein, a WTRU may send an anticipated measurement report upon one or more of a plurality of, e.g., several, conditions being satisfied. A WTRU may be further configured to, based on confidence reports, send an anticipated measurement report based on additional and/or different rules.

For example, a WTRU may be configured to send a report if at a time t_evt, after making a number of predictions, the WTRU may have predicted the event will fall within the prediction range for a given confidence percentage value. For example, after determining a number of predictions, e.g., five predictions, with a determined percentage (x %) confidence that the predictions fall within a range, the WTRU may send the predictions.

A WTRU may be configured to send a report if at a time t_evt, after a number of predictions, the WTRU may have predicted the event will fall under an upper boundary of a prediction range associated with a confidence percentage value. After a determining a number of predictions, e.g., five predictions, with a determined percentage (x %) of confidence that the prediction falls under an upper boundary of a prediction range, the WTRU may send the predictions.

A WTRU may be configured to send a report if at a time t_evt, after a number of predictions, the WTRU may have predicted the event will fall above a lower boundary of a prediction range for a given confidence percentage value. For example, after determining a number of predictions, e.g., five predictions, with a determined percentage (x %) of confidence that the prediction falls above a lower boundary range, the WTRU may send the predictions.

A WTRU may be configured to send a report comprising predictions after considering predictions associated with consecutive timesteps. For example, a WTRU may send predictions if after making of number of predictions at consecutive time steps, the WTRU may have predicted the event will fall within the prediction range for a given confidence percentage value. A WTRU may be configured to send predictions if after making a number of predictions at consecutive time steps, the WTRU may have predicted the event will fall under an upper boundary of a prediction range associated with a confidence percentage value. A WTRU may be configured to send predictions if after making a number of predictions at consecutive time steps, the WTRU may have predicted the event will fall above a lower boundary of a prediction range for a given confidence percentage value.

A WTRU may be configured to send a report comprising predictions after considering predictions associated with various distributions of timesteps. The distribution of timesteps may be provided to the WTRU by, for example, the network. The distribution may be any suitable distribution and the timesteps associated with the distribution may or may not be consecutive. A WTRU may send predictions if after making of number of predictions at time steps across a defined distribution, the WTRU may have predicted the event will fall within the prediction range for a given confidence percentage value. A WTRU may be configured to send predictions if after making a number of predictions at time steps across a defined distribution, the WTRU may have predicted the event will fall under an upper boundary of a prediction range associated with a confidence percentage value. A WTRU may be configured to send predictions if after making a number of predictions at time steps across a defined distribution, the WTRU may have predicted the event will fall above a lower boundary of a prediction range for a given confidence percentage value.

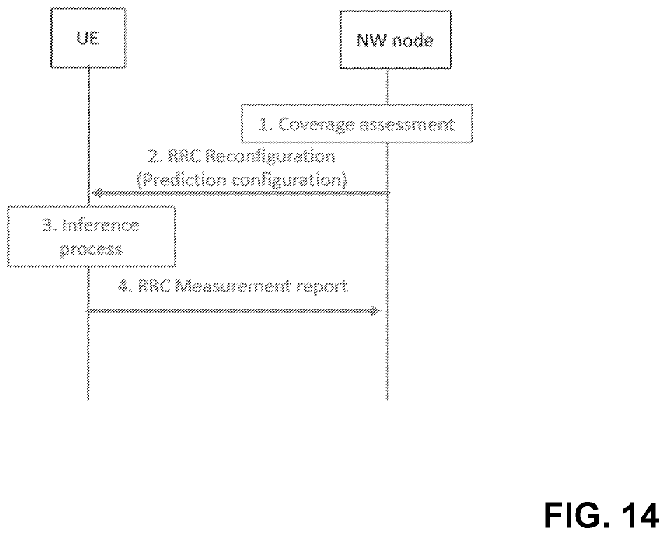

FIG. 14 depicts example signaling for WTRU measurement prediction reporting processing. As shown, a layer 3 message diagram may be used to illustrate the configuration of the WTRU and the transmission of predicted measurements or events back to the network.

Referring to FIG. 14, at reference 1, a network node may perform a coverage assessment using an internal database and may prepare the inference procedure for the WTRU. The network may derive which cells for which the WTRU may perform inference and may determine WTRU configuration information consistent with the discussions herein. At reference 2, the network node may send the configuration to the WTRU. At reference 3, the WTRU may perform the inference process as described herein. At reference 4, the WTRU may report the predictions back to the network node using the reporting configuration.

Although features and elements described herein are described in particular combinations, each feature or element may be used alone without the other features and elements of the preferred embodiments, or in various combinations with or without other features and elements.

The description herein may be provided for exemplary purposes and does not limit in any way the applicability of the described systems, methods, and instrumentalities to other wireless technologies and/or to wireless technology using different principles, when applicable. The term network in this disclosure may refer to one or more gNBs which in turn may be associated with one or more Transmission/Reception Points (TRPs) or any other node in the radio access network.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit and receive unit (WTRU) comprising:
a processor configured to:
determine at least one measurement;
determine, based on the at least one measurement, a predicted event and a predicted time associated with the predicted event;
determine, based on the predicted event, the predicted time, and a time offset that indicates a difference between a current time and the predicted time, to send a report that indicates the predicted event; and
send the report that indicates the predicted event.

22. The WTRU of claim 21,
wherein the predicted time comprises a time interval.

23. The WTRU of claim 21,
wherein the at least one measurement comprises at least one predicted measurement.

24. The WTRU of claim 21,
wherein the predicted event comprises the at least one measurement being less than a threshold.

25. The WTRU of claim 23, wherein the predicted measurement is a predicted air interface measurement.

26. The WTRU of claim 21,
wherein the processor is further configured to determine a predicted confidence associated with the predicted event; and
wherein the report that indicates the predicted event comprises an indication of the predicted event, the at least one measurement, and the predicted confidence.

27. The WTRU of claim 21,
wherein the processor configured to determine, based on the predicted event, the predicted time, and the time offset, to send the report that indicates the predicted event is further configured to send the report that indicates the predicted event on a condition that a difference between a current time and the predicted time is greater than the time offset.

28. The WTRU of claim 21,
wherein the processor is further configured to receive configuration information, the configuration information comprising information that identifies the time offset.

29. The WTRU of claim 28,
wherein the configuration information further comprises information that identifies the predicted event.

30. The WTRU of claim 23,
wherein the processor configured to determine the at least one predicted measurement is configured to determine a first predicted measurement and a second predicted measurement; and
wherein the processor configured to determine, based on the at least one predicted measurement, the predicted event and the predicted time associated with the predicted event is further configured to determine, based on the second predicted measurement, the predicted event and the predicted time associated with the predicted event.

31. A method comprising:
determining at least one measurement;
determining, based on the at least one measurement, a predicted event and a predicted time associated with the predicted event;
determining, based on the predicted event, the predicted time, and a time offset that indicates a difference between a current time and the predicted time, to send a report that indicates the predicted event; and
sending the report that indicates the predicted event.

32. The method of claim 31,
wherein the predicted time comprises a time interval.

33. The method of claim 31,
wherein the at least one measurement comprises at least one predicted measurement; and
wherein the predicted event comprises the at least one predicted measurement being less than a threshold.

34. The method of claim 31, further comprising determining a predicted confidence associated with the predicted event;
wherein the report that indicates the predicted event comprises an indication of the predicted event, the at least one measurement, and the predicted confidence.

35. The method of claim 31,
wherein determining, based on the predicted event, the predicted time, and the time offset, to send the report that indicates the predicted event further comprises sending the report that indicates the predicted event on a condition that a difference between a current time and the predicted time is greater than the time offset.

36. The method of claim 31,
wherein determining the at least one measurement comprises determining a first measurement and a second measurement; and
wherein determining, based on the at least one measurement, the predicted event and the predicted time associated with the predicted event comprises determining, based on the second measurement, the predicted event and the predicted time associated with the predicted event.

37. A wireless transmit and receive unit (WTRU) comprising:
a processor configured to:
determine a plurality of measurements;
determine, based on one of the plurality of measurements, a predicted event and a predicted time associated with the predicted event, the predicted event associated with the one of the plurality of measurements that satisfies a threshold;
determine a difference between a current time and the predicted time; and
on a condition the difference between the current time and the predicted time is more than a predetermined time offset, send to a network node a report that indicates the predicted event.

38. The WTRU of claim 37,
wherein the processor is further configured to determine a predicted confidence associated with the predicted event;
wherein the report that indicates the predicted event comprises an indication of the predicted event, the one of the plurality of measurements, and the predicted confidence.

39. The WTRU of claim 37,
wherein the predicted time comprises a time interval.

40. The WTRU of claim 7,
wherein the one of the plurality of measurements comprises at least one predicted measurement.
